(19) United States
(12) Patent Application Publication
(10) Pub. No.: US 2014/0116572 A1
(43) Pub. Date: May 1, 2014

(54) VEHICLE FLUID EXCHANGE WITH TELEMETRY DATA TRANSFER

(71) Applicants: Matthew Flournoy, South Bend, IN (US); Frank Casale, Fishers, IN (US)

(72) Inventors: Matthew Flournoy, South Bend, IN (US); Frank Casale, Fishers, IN (US)

(21) Appl. No.: 14/062,029

(22) Filed: Oct. 24, 2013

Related U.S. Application Data
(60) Provisional application No. 61/718,862, filed on Oct. 26, 2012.

(51) Int. Cl. B67D 7/78

(52) U.S. Cl. CPC B67D 7/78
USPC 141/94

(57) ABSTRACT

The present invention is a fluid exchange machine, such as a brake fluid exchange machine or an automatic transmission fluid exchange machine, that includes a new fluid tank, a waste fluid collector, a pump for introducing new fluid into a vehicle, and a controller for managing the operation of the fluid exchange machine. Coupled to the controller is a global positioning satellite (GPS) receiver that can identify the location of the fluid exchange machine at all times, and a wireless transmitter that can wirelessly transmit the location of the fluid exchange machine to a remote location. In a preferred embodiment, the wireless transmitter can also track and communicate the number and time of each fluid exchange operation, and the amount of fluid, so the recipient of the data can discern where the fluid exchange machine is at all times, how many fluid exchange operations the machine performs, and when each fluid exchange operation is performed.

### CROSS-REFERENCES TO RELATED APPLICATIONS

This application claims priority from U.S. Application No. 61/718,862, filed Oct. 26, 2012 incorporated by reference in its entirety.

### BACKGROUND

Fluid exchange machines for replacing and replenishing fluids in a vehicle, such as hydraulic or cooling systems, are well known in the art. The assignee of the present invention, Norco Industries, manufactures and sells a line of these types of machines, some of which are multi-purpose, and can be found at www.flodynamics.com. Automatic transmission fluid exchangers, power steering fluid exchangers, and brake fluid exchangers are predominantly the main vehicle fluid exchange machines, although not exclusive.

Many of these fluid exchange machines are purchased by companies who sell the automotive fluids, such as transmission fluid or brake fluid. In many cases, the companies then provide these machines to service stations, repair shops, and other vehicle maintenance businesses at a reduced price under an agreement that the service station will only purchase the replacement fluids from them. The service stations get a free or reduced price fluid exchange machine, and the fluid supplier has a customer who is obligated to purchase its product exclusively.

The problem that arises, however, is that the fluid supplier has no way of verifying that the service station is using the supplier's products exclusively. Many times a service station will begin to use cheaper oils or fluids, and under-report the number of services that it is performing. Alternatively, the service station can move the fluid exchange machine offsite and perform the fluid exchanges at a location unknown to the fluid supplier, preventing monitoring. The fluid supplier is helpless to prevent this type of fraud without access to the service station's facilities. The present invention is directed to a solution to this problem.

### SUMMARY OF THE INVENTION

The present invention is a fluid exchange machine with remote data exchange that can wirelessly communicate to a remote location each time a service operation takes place. In a preferred embodiment, the information can be sent to the shop owner, a supplier, sent to a website, or otherwise communicated to the fluid supplier electronically and remotely. The data exchange can forward the number of fluid exchange operations, the amount of fluid used, the last time the machine was used, and the location of the fluid exchange operation to the fluid supplier, who can then verify both the number of fluid exchange operations, the amount of fluid used, and the location of the machine. The shop owner can print service reports, and the fluid supplier can monitor the service station and ensure an accurate accounting of the service station's operation and that the service station is purchasing all of the automotive fluids from the supplier. In this way, the agreements between the parties can be assuredly complied with.

The present invention is a fluid exchange machine, such as a brake fluid exchange machine or an automatic transmission fluid exchange machine, coolant, power steering, transmission differential, or the like, that includes a new fluid tank, a waste fluid tank or collector, a pump for introducing new fluid into a vehicle, and a controller for managing the operation of the fluid exchange machine. Coupled to the controller is a global positioning satellite (GPS) receiver that can identify the location of the fluid exchange machine when activated, and a wireless transmitter that can wirelessly transmit the location of the fluid exchange machine to a remote location. In a preferred embodiment, the wireless transmitter can also track and communicate the number and time of each fluid exchange operation, so the recipient of the data can discern where the fluid exchange machine is at all times, how many fluid exchange operations the machine performs, and when each fluid exchange operation is performed. The machine may also report to the remote location any diagnostic or maintenance issues relevant to the machine's operation. With this information, compliance with existing agreements can be assured.

### BRIEF DESCRIPTION OF THE DRAWINGS

FIG. 1 is an elevated, perspective view of a first embodiment of the present invention in the form of a brake fluid exchange machine.

FIG. 2 is a schematic of a first embodiment of the fluid exchange machine of the present invention.

FIG. 3 is schematic of a communication network between a fluid exchange machine and a central server.

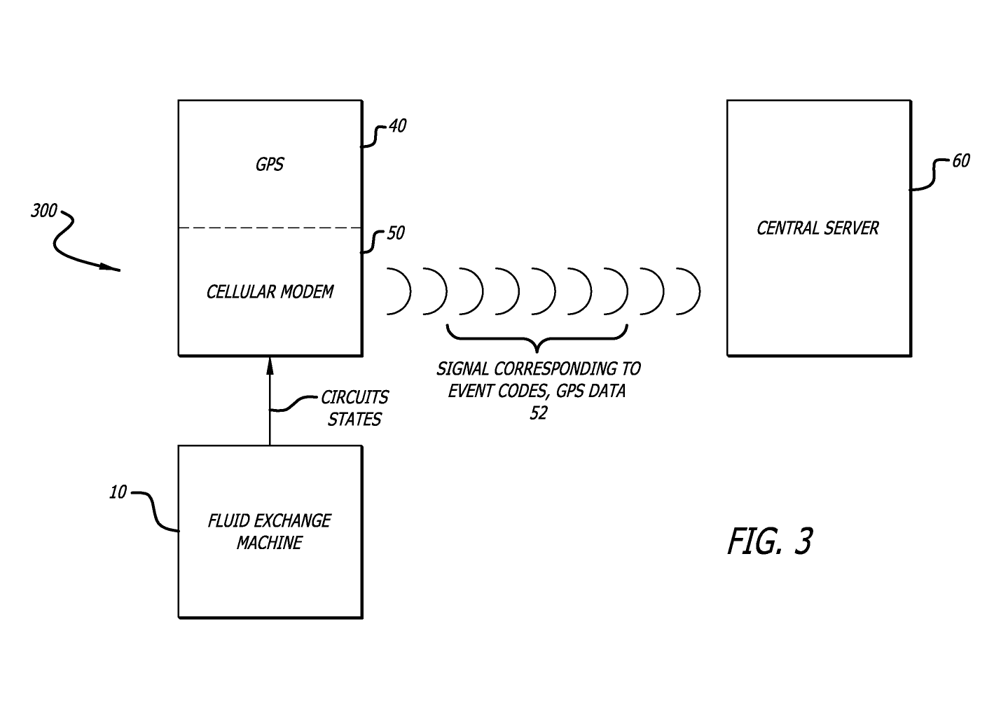

FIG. 4 is a diagram of a website that can be populated remotely by the present invention.

FIG. 5 is a sample website featuring a map that reflects locations where the machine of the present invention has been used.

FIG. 6 is a sample website that can be populated remotely by the present invention showing each use by the machine.

### DETAILED DESCRIPTION OF THE PREFERRED EMBODIMENTS

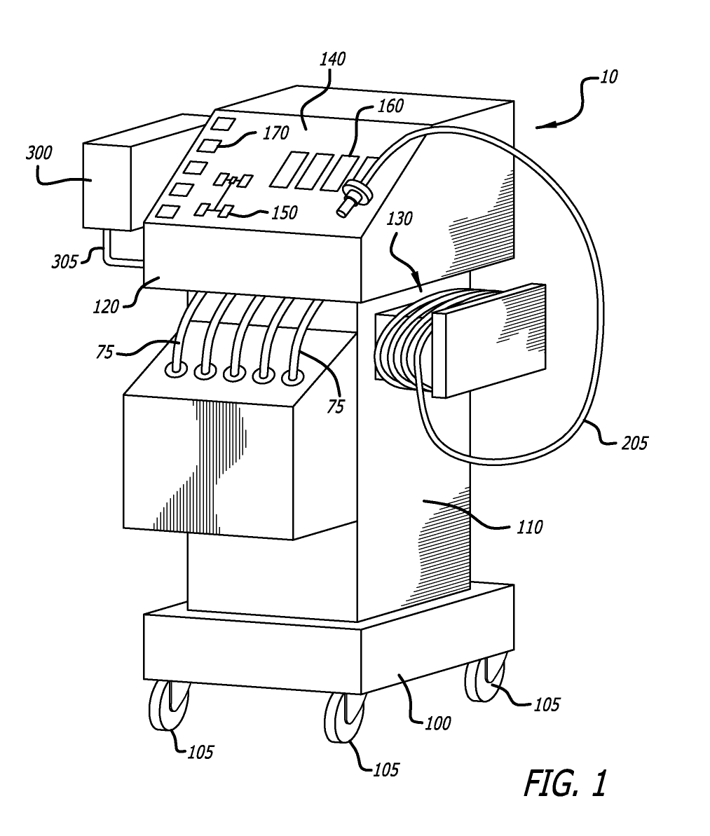

There are a number of commercial automotive fluid exchange machines on the market, and the details of the fluid exchange machine are not essential to the understanding of the present invention. Examples of fluid exchange machines can be found, e.g., in U.S. Pat. Nos. 6,035,903, 5,626,170, 8,104,522, 7,597,121, 6,959,740, 6,877,531, and 6,772,802, the contents of each of which are fully incorporated herein by reference. The operation of the fluid exchange machine will be described only basically herein using the schematic of FIG. 1.

FIG. 1 depicts a fluid exchange machine 10, such as a brake fluid exchange machine, which is used to withdraw used fluid from a vehicles hydraulic brake system and replenish the brake system with clean, fresh brake fluid. It is to be understood that the present invention is not intended to be limited to a brake fluid exchange machine, but rather applies to all vehicle fluid replacement machines such as brake, transmission, power steering, oil, and the like. The fluid exchange machine 10 is a combination of plumbing components (pumps, tubing, valves) and electrical components (processors, electrical cables, display equipment) enclosed in a durable plastic housing 110. The housing 110 includes a platform 100 with four caster wheels 105 that allow the fluid exchange machine 10 to be rolled quickly into position as needed to service the vehicle. In the housing is a twenty quart waste fluid tank 18, a seven quart new fluid tank 16, an electrical system powered by a twelve volt battery such as those found in most passenger vehicles, a vacuum pump 32, and a pressure pump 22. Some machines use another type of collector for the used fluid, and the invention is not limited to used fluid tanks.

The housing 110 includes a podium-like structure 120 having a column 130 and display/control panel 140. The controls for operating the machine and the sight glasses to evaluate the progress of the fluid exchange process are located on the display/control panel area 140. The display may include, for example, a face plate with an illuminated status diagram 150 to track the progress of the fluid exchange operation, five separate sight glasses 160 to visually check the transformation of the used fluid to fresh fluid, and buttons 170 for operating the machine manually rather than automatically. Said buttons 170 include a master cylinder pressure button for detecting leaks around the master cylinder cap, an anti-lock brake cylinder button for removing brake fluid from the ABS reservoir, a forward axel start button for initiating withdrawal of the used fluid from the front brake axel cylinders, and rearward axel start button for initiating withdrawal of the used fluid from the rear brake cylinders. An “add fluid/drain new tank” button activates the pressure pump to force new fluid from the new fluid tank, which could be used to top off the system or to evacuate the new fluid tank. A “remove fluid” button actuates the vacuum pump 32 to withdraw fluid through any of the attached fluid lines. A “drain waste tank” button can be used to evacuate the used fluid tank in the machine, and a “prime” button is used to prime the pumps 22, 32 for operation. Finally, an oversized “stop” button terminates the operation of the machine.

A schematic of the vehicle brake system may be included on the control area 140 overlaying LED lights that show the cylinder being drained during the fluid exchange operation. That is, the rear passenger cylinder LED illuminates as that cylinder is evacuated, and then the rear driver cylinder LED illuminates and so on. Information/Warning LED lights also are found on the control area 140, including an indicator for the ABS fluid exchange, a warning light when the waste tank is full, a warning when the new fluid tank is empty, and an indicator light showing the machine is operation. In addition, a separate sight glass 160 is provided for each fluid line connecting the vacuum pump 32 to the rear passenger wheel, the rear driver wheel, the front passenger wheel, the front driver wheel, and the ABS system. As the fluid exchange process proceeds, the fluid is pumped through the sight glass for visual inspection. The fluid in the sight glass will initially reflect the dark, murky color reflecting the oxidized used fluid and then gradually change to a reddish clearer color indicative of new, unoxidized brake fluid. Beneath the control area 140 is a controller 20 in the form of a circuit board coupled to a microprocessor for controlling the operation of the fluid exchange machine, including pressure sensitive switches beneath the buttons on the control area that translate the user's physical depressing of the buttons into commands for the controller 20. The housing 110 may also include five lines 75 of approximately fifteen feet that allow the machine to connect with the four bleeder valves of the respective wheel cylinders and the ABS system if present, along with hoses 205 that connect the fluid exchange machine 10 with a vehicle 24.

In the present invention, the fluid exchange machine 10 is equipped with a telemetry unit 300 that is connected to the controller 20 of the fluid exchange machine 10 via cable 305. As explained in more detail below, the telemetry unit 300 can monitor the status of the fluid exchange machine through the controller 20, including the status of various circuits or sensors depending upon the needs of the system.

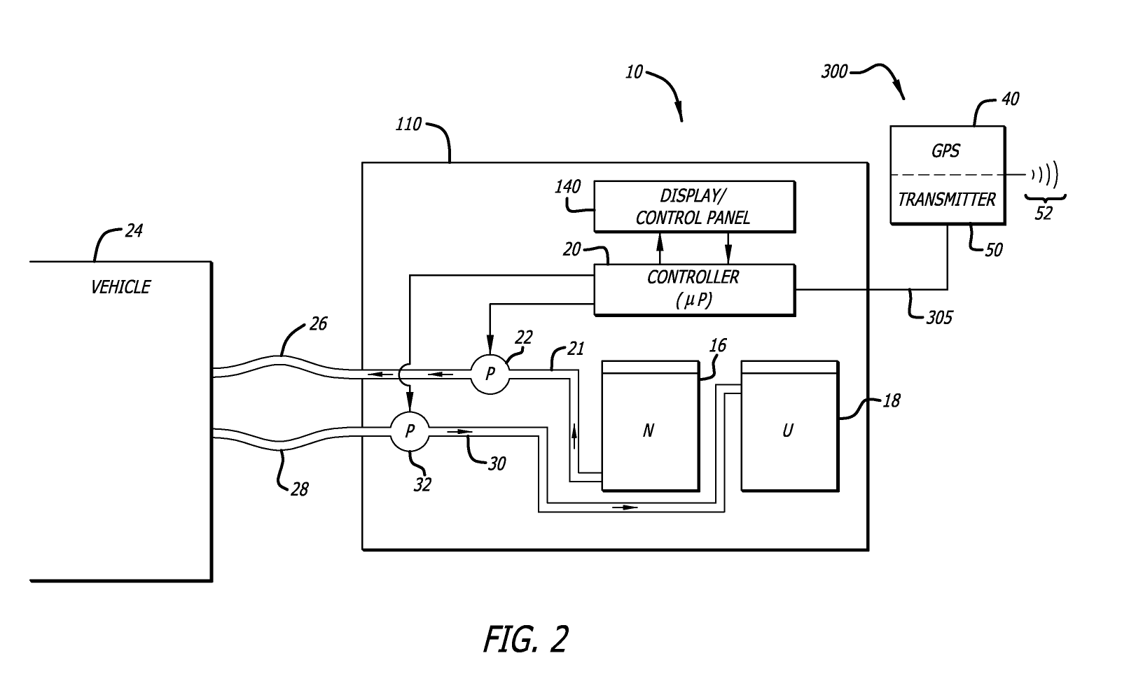

FIG. 2 is a generic schematic of a more general fluid exchange machine 10 and its plumbing connections. A new fluid tank 16 within the housing 110 is connected by a fluid conduit 21 to the pressure pump 22, which forces fresh vehicle replacement fluid from the new fluid tank 16 to the vehicle to be serviced through hose 26. In the case of a brake fluid replacement machine, a pressure sensor (not shown) measures the fluid pressure in the master cylinder of the vehicle 24 and communicates the pressure to the microprocessor of the controller 20. On the used fluid side f the system, the vehicle's hydraulic system is connected to the vacuum pump 32 through hose 28 and fluid conduit 30. In the case of a brake fluid replacement machine, single conduit 30 could be replaced with a multi-valve solenoid (not shown) that connects to respective cylinders of the vehicle's brake system or the ABS reservoir if present. The controller 20 of the fluid exchange machine 10 controls the vacuum pump 32 and, if present, the opening and closing of the manifold by actuating the solenoid, which controls the sequence of the fluid withdrawal from the brake system. The vacuum pump 32 evacuates the used fluid to the used fluid tank 18 in the brake machine housing 110 via fluid conduit 30.

First, the new fluid tank 16 is filled with fresh brake fluid and the used fluid tank 18 is drained of any existing used fluid from a previous fluid exchange operation. Suction hose 28 is connected to the vehicle 24, and after depressing the “remove fluid” button on the control panel 140 the used fluid in the vehicle is substantially removed. The “stop” button is used to terminate the draining process. The fluid hose 26 is then connected to the vehicle 24 using an appropriate adapter. With the machine connected to the vehicle, the user depresses the “start” button, whereupon the machine will automatically begin pumping new fluid from the new fluid tank 16 through hose 26 and into the vehicle's hydraulic system. Once the fluid exchange is complete, the hoses are disconnected and adjustments to the fluid level, either removing or adding fluid, can be completed using the appropriate buttons.

In some fluid exchange machines, the used fluid is withdrawn from the vehicle with a vacuum pump 32, while other systems rely on the vehicle's own pumping system to evacuate the used fluid. The controller 20 controls the pumps 22,32, and concludes the operation when the new fluid in the vehicle 24 has replaced the used fluid. The details of other exemplary fluid exchange machines are found in the specifications of the patents cited above and incorporated herein by reference.

In the present invention, a telemetry unit 300 is connected to the controller 20 of a fluid exchange machine 10, where the telemetry unit 300 includes a GPS receiver 40 for receiving GPS positioning data. As is known in the art, the GPS receiver receives data from various GPS satellites and determines a location of the receiver from the satellite signals. In an alternate embodiment, the GPS receiver 40 can be built into circuit board of the controller 20 of the fluid exchange machine 10, or it can be a separate unit that plugs into directly into the controller 20. An example of a GPS receiver is offered by Net Irrigate LLC of Bloomington, Ind. The GPS receiver 40 is also equipped with a wireless transmitter 50 for communicating wirelessly with a remote location, such as a website or email address, or other data recipient such as a text message or voice message, where the data recipient is remote from the fluid exchange machine 10. The wireless transmitter 50 automatically, periodically, or in response to a request, sends a signal 52 corresponding to the GPS determined location of the fluid exchange machine 10 to the remote data recipient, where the location data of the fluid exchange machine 10 can be tracked and stored.

The GPS receiver 40, in a preferred embodiment, can monitor the state of certain selected circuits within the fluid exchange machine 10, such as the Power on/off switch, the initiate pump circuit, or the like. The GPS receiver 40, using a wireless transmitter 50 such as a cellular modem for example, sends wireless cellular signals 52 corresponding to event codes to a remote central server 60 based on the state of the selected circuits. The server 60 is maintained by an entity that monitors the use and location of the fluid exchange machine, and the server 60 is capable of processing the event codes embedded in the cellular signals into relevant management data. For example, data can include the number of times a machine is powered up for a service operation, and the date/time of each service operation. Depending upon the type of machine and the requirements of the data user, various other conditions and states of the fluid exchange machine can be monitored and stored.

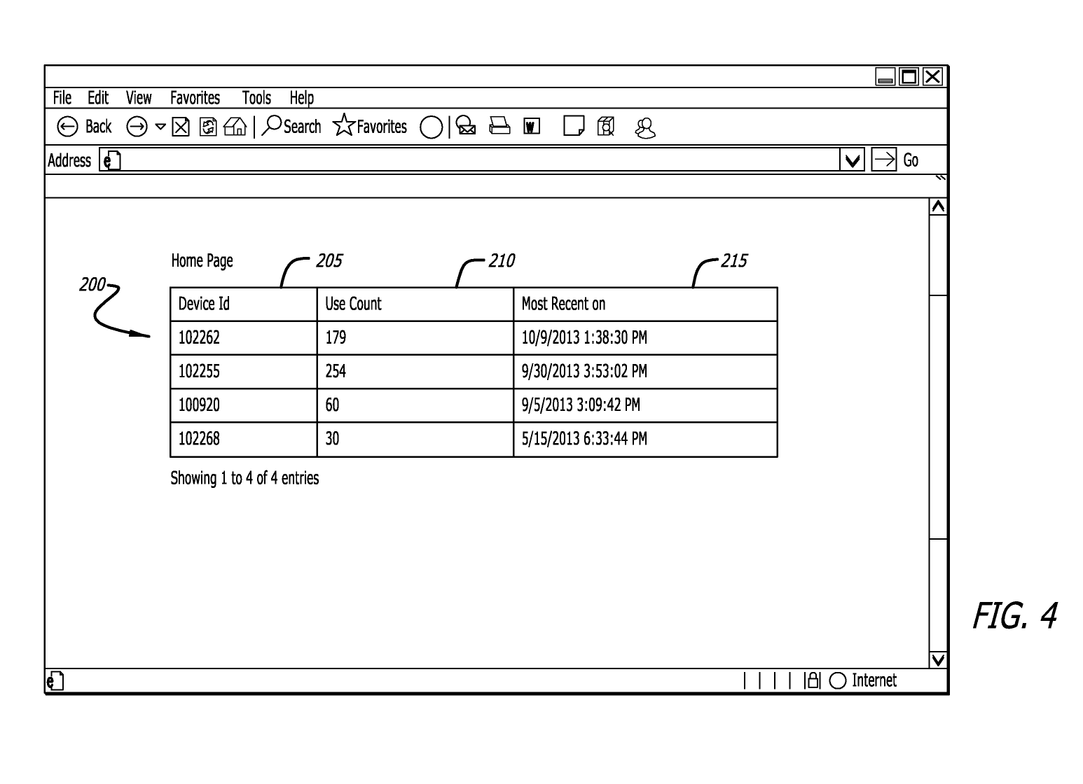

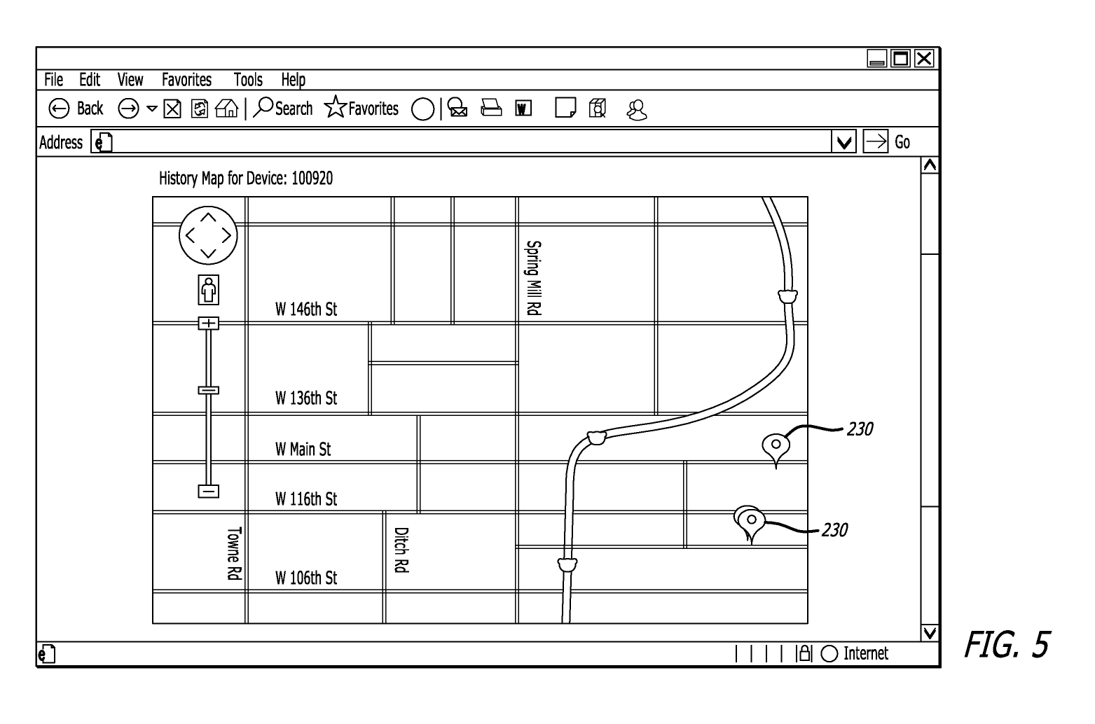

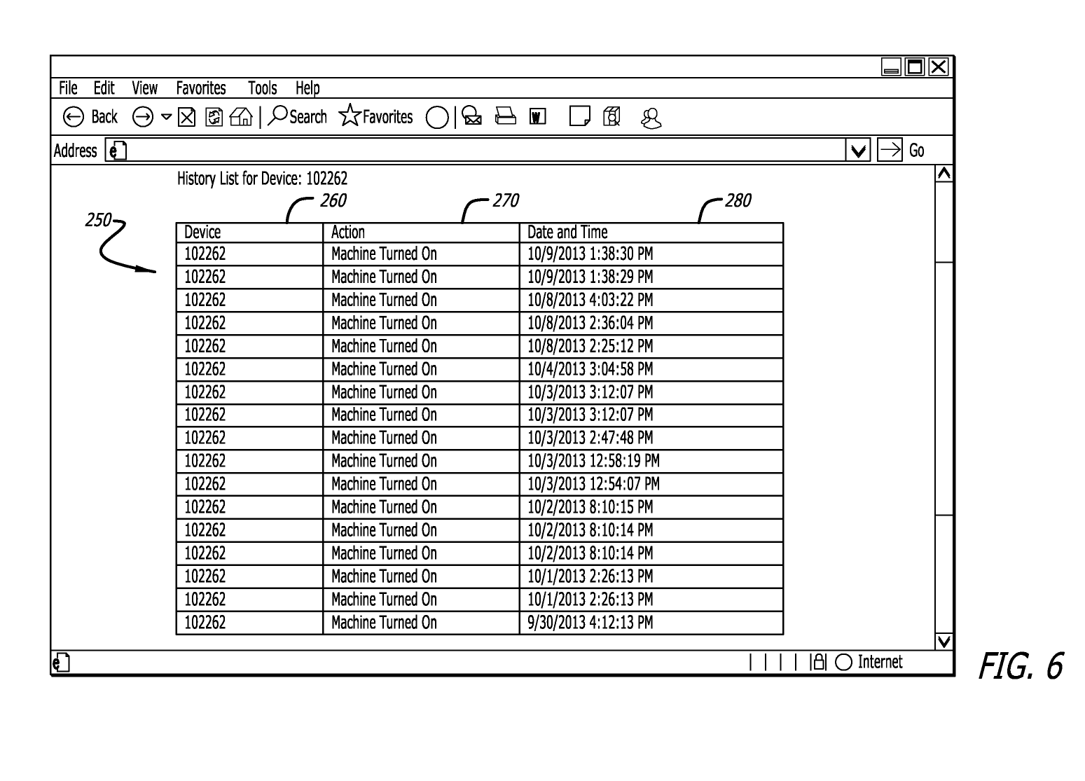

FIG. 4 illustrates a web page where various machines can be tracked all in a single location. The web page is set up so that the machines can transmit data directly to the web page, where an operator can access the information from anywhere where internet access is available. The web page includes a table that has multiple headers, including a fluid exchange machine identification number or code 205, a “use” count 210 totaling the number of times the machine has been used, and a “most recent use” column 215. At a glance, a user can determine the amount of use and most recent use for each machine in the inventory. From this home page, each machine can be investigated further with a mouse click or the like. For example, in FIG. 5, a map page is created and linked from the home page of FIG. 4, showing every location where a particular fluid exchange machine has been turned on. If the machine has been used offsite, the user will be able to track the location and number of offsite uses. Markers 230 show the GPS derived locations for every use by the selected machine. FIG. 6 illustrates another sample web page including a table 250 that displays information on a history of a particular fluid exchange machine from the home page of FIG. 4. The table 250 includes a column listing the machine's identification 260, a column for the type of activity 270, and a time and date column 280 for the time and date that the activity occurred. Using this web page, the activity for each machine can be monitored to determine the frequency and type of use for each machine. Moreover, information can also be added such as the amount of new fluid used or the duration of each use to more accurately assess the usage of the machine.

The telemetry unit 300 of the present invention can transmit usage and location data to a variety of other recipients, including a smart phone, tablet, laptop, stored on a remote server, and the like. In this manner, each fluid exchange machine can be monitored remotely to ensure that agreements are being complied with, and that the usage of the fluid exchange machine falls within agreed parameters.

While the present invention has been described using various exemplary embodiments, it is to be understood that many modifications are possible with the invention, and the invention should not be limited by the various described embodiments. Other types of vehicle fluid exchange machines are within the scope of the invention, and it is intended that the present invention cover all such modifications and other embodiments. Accordingly, the scope of the present invention is properly measured by the appended claims, using their plain and ordinary meanings, without limitation to the figures and descriptions set forth above.

I Claim:

1. A vehicle fluid exchange machine comprising:
a housing;
a new fluid storage tank;
a used fluid storage collector;
a user-actuated display panel;
a controller coupled to the control panel;
a pump coupled to the controller, and in fluid communication with the new fluid storage tank;
a first conduit for delivering the new fluid from the fluid exchange machine to the vehicle;
a second conduit for conveying used fluid from the vehicle to the used fluid storage collector; and
a GPS receiver/transmitter connected to the controller, said GPS receiver including a wireless transmitter for wirelessly transmitting location data relating to the fluid exchange machine to a remote data recipient.

2. The vehicle fluid exchange machine of claim 1, wherein the GPS receiver/transmitter receives fluid exchange operation data from the controller, and wirelessly transmits the fluid exchange operation data to the remote data recipient.

3. The vehicle fluid exchange machine of claim 2, wherein the fluid exchange operation data includes a time corresponding to each fluid exchange operation.

4. The vehicle fluid exchange machine of claim 2, wherein the fluid exchange operation data includes a number of fluid exchange operations performed by the fluid exchange machine.

5. The vehicle fluid exchange machine of claim 2, wherein the remote data recipient is a web site.

6. The vehicle fluid exchange machine of claim 2, wherein the remote data recipient is an e-mail address.

7. The vehicle fluid exchange machine of claim 2, wherein the remote data recipient is an internet address, such that the data is incorporated into a web site.

8. The vehicle fluid exchange machine of claim 2, wherein the GPS receiver/transmitter is outside of the housing.

9. The vehicle fluid exchange machine of claim 2, wherein the GPS receiver/transmitter is inside of the housing.

10. The vehicle fluid exchange machine of claim 2, wherein the GPS receiver/transmitter monitors the status of selected circuits within the fluid exchange machine, and transmits a signal to a central server via a cellular modem.
